(19) United States
(12) Patent Application Publication
(10) Pub. No.: US 2024/0401501 A1
(43) Pub. Date: Dec. 5, 2024

(54) POWER GENERATION SYSTEM, CONTROL DEVICE, AND CONTROL METHOD

(71) Applicant: MITSUBISHI HEAVY INDUSTRIES, LTD., Tokyo (JP)

(72) Inventor: Naoyuki NAGAFUCHI, Tokyo (JP)

(21) Appl. No.: 18/699,495

(22) PCT Filed: Sep. 1, 2022
(86) PCT No.: PCT/JP2022/032967

§ 371 Date: Apr. 8, 2024

(30) Foreign Application Priority Data
Nov. 17, 2021 (JP) 2021-186958

(51) Int. Cl. F01K 23/06; F01D 15/10; F01D 19/02

(52) U.S. Cl. CPC F01K 23/06; F01D 15/10; F01D 19/02; F05D 2220/31; F05D 2220/32; F05D 2220/72; F05D 2220/74

(57) ABSTRACT

This power generation system comprises: a gas turbine; a power generator; a first clutch that engages or disengages with the rotation shaft of the gas turbine and the rotation shaft of the power generator; a rotation drive unit that rotationally drives the gas turbine; a control unit that controls the rotation drive unit according to the exhaust temperature of the gas turbine to rotationally drive the gas turbine in a case in which the power generator is operated in synchronous phase modification while the first clutch is in a disengaged state.

### TECHNICAL FIELD

The present disclosure relates to a power generation system, a control device, and a control method. The present application claims priority based on Japanese Patent Application No. 2021-186958 filed in Japan on Nov. 17, 2021, the content of which is incorporated herein by reference.

### BACKGROUND ART

PTL 1 describes a configuration example of a power generation system that uses a generator for both generation of active power and generation of reactive power by disconnecting mechanical connection between a prime mover and the generator or changing a mechanical input. In this power generation system, reactive power can be generated by disconnecting the generator from the prime mover and operating the generator as a synchronous condenser. In addition, in this power generation system, the prime mover and the generator are mechanically connected to each other by using a wet clutch.

### CITATION LIST

### Patent Literature

[PTL 1] Japanese Unexamined Patent Publication No. 2020-48377

### SUMMARY OF INVENTION

### Technical Problem

However, in the power generation system described in PTL 1, since the prime mover and the generator are mechanically connected to each other by using a wet clutch, the following problems may occur. That is, in the wet clutch, in a state where the clutch is disengaged, a friction plate on a driven side is dragged and rotated by a friction plate on a drive side due to the viscosity of oil, that is, so-called corotation may occur. In such a case, in a case where the generator is operated as the synchronous condenser in a state where the clutch is disengaged, there is a problem in that an operation state different from that intended on a prime mover side may occur.

The present disclosure has been made to solve the above-mentioned problems. It is an object of the present invention to provide a power generation system, a control device, and a control method capable of controlling the operation state of a device connected to the generator via the clutch in a case where the generator is operated as the synchronous condenser in a state where the clutch is disengaged.

### Solution to Problem

In order to solve the above problems, according to the present disclosure, there is provided a power generation system including: a gas turbine; a generator; a first clutch that engages or disengages with a rotary shaft of the gas turbine and a rotary shaft of the generator; a rotation drive unit that rotationally drives the gas turbine; and a controller that controls the rotation drive unit in accordance with an exhaust temperature of the gas turbine to rotationally drive the gas turbine in a case in which the generator is in a synchronous phase modification operation while the first clutch is in a disengaged state.

According to the present disclosure, there is provided a control device that controls a power generation system including a gas turbine, a generator, a first clutch that engages or disengages with a rotary shaft of the gas turbine and a rotary shaft of the generator, and a rotation drive unit that rotationally drives the gas turbine, the control device including: a controller that controls the rotation drive unit in accordance with an exhaust temperature of the gas turbine to rotationally drive the gas turbine in a case in which the generator is in a synchronous phase modification operation while the first clutch is in a disengaged state.

According to the present disclosure, there is provided a control method of a power generation system including a gas turbine, a generator, a first clutch that engages or disengages with a rotary shaft of the gas turbine and a rotary shaft of the generator, and a rotation drive unit that rotationally drives the gas turbine, the control method including: controlling the rotation drive unit in accordance with an exhaust temperature of the gas turbine to rotationally drive the gas turbine in a case in which the generator is in a synchronous phase modification operation while the first clutch is in a disengaged state.

### Advantageous Effects of Invention

According to the power generation system, the control device, and the control method of the present disclosure, in a case where the generator is operated as the synchronous condenser in a state where the clutch is disengaged, it is possible to control the operation state of the gas turbine which is a device connected to the generator via the clutch.

### BRIEF DESCRIPTION OF DRAWINGS

FIG. 1 is a diagram showing a configuration example of a power generation system according to an embodiment of the present disclosure.

FIG. 2 is a diagram showing an example of measurement points of the power generation system according to the embodiment of the present disclosure.

FIG. 3 is a diagram showing an example of a control processing flow during a synchronous phase modification operation of the power generation system according to the embodiment of the present disclosure.

FIG. 4 is a diagram showing an example of a control flow of a bottoming warm-up operation mode of the power generation system according to the embodiment of the present disclosure.

FIG. 5 is a diagram showing an operation example during the synchronous phase modification operation of the power generation system according to the embodiment of the present disclosure.

FIG. 6 is a diagram showing an example of a control processing flow during a switching operation from the synchronous phase modification operation to an active power operation of the power generation system according to the embodiment of the present disclosure.

FIG. 7 is a schematic block diagram showing a configuration of a computer according to at least one embodiment.

### DESCRIPTION OF EMBODIMENTS

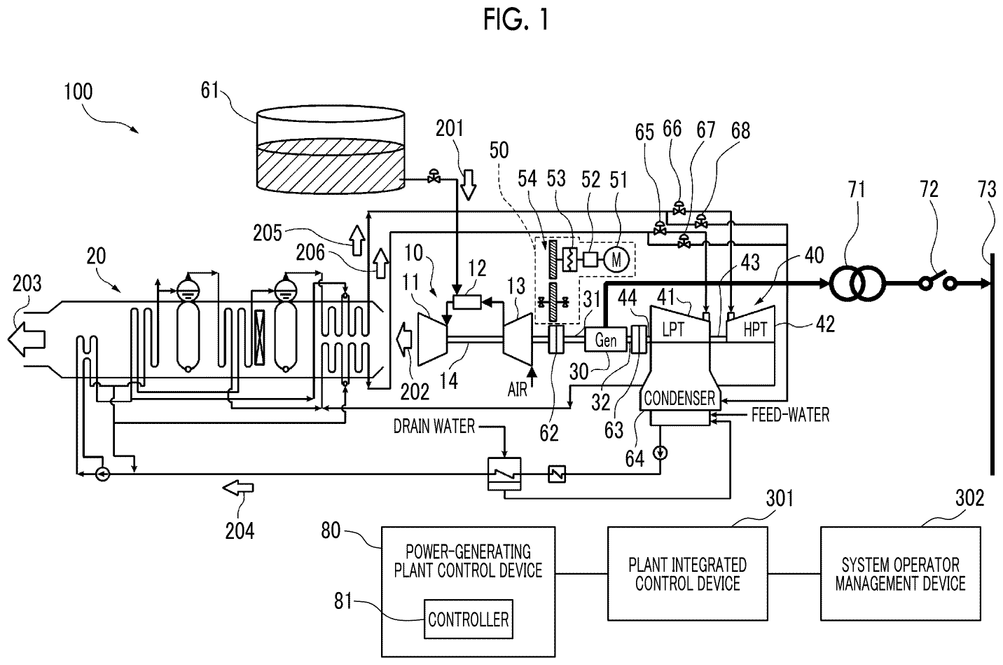

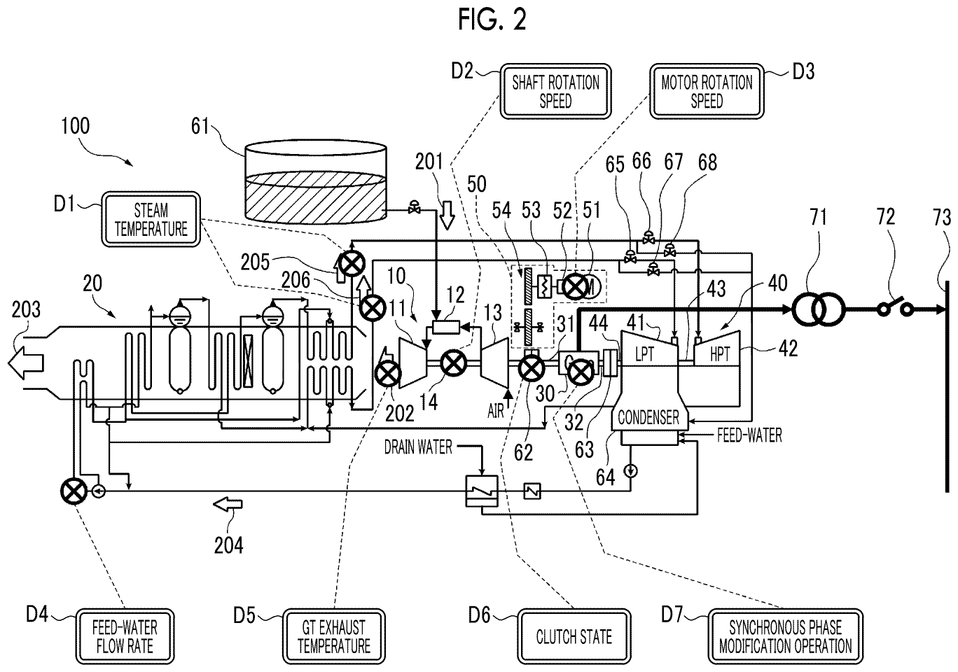

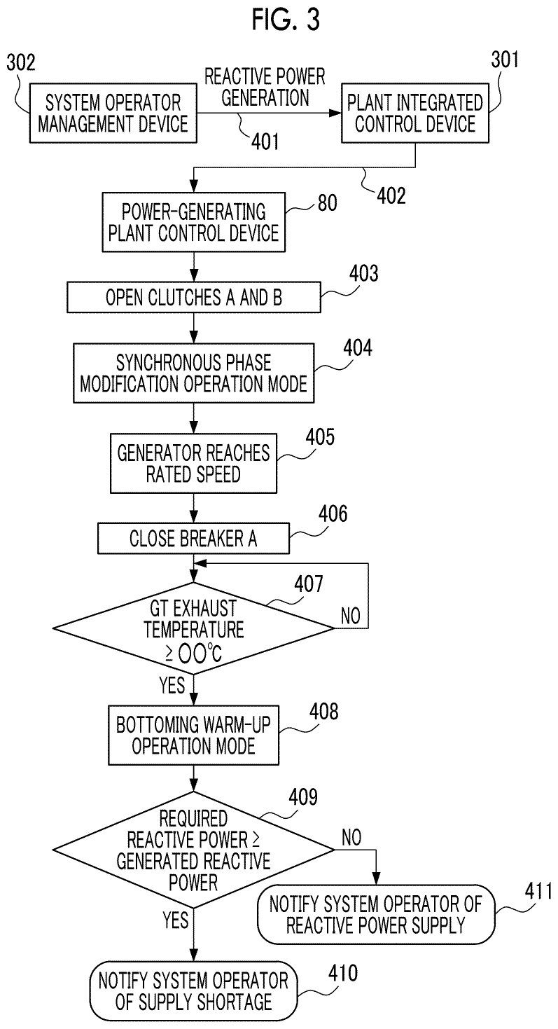

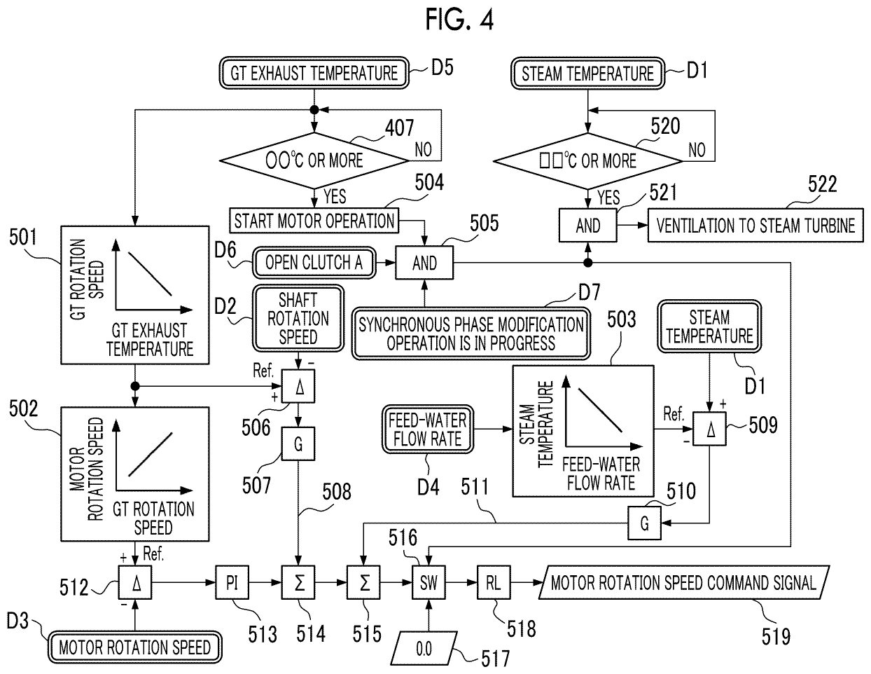

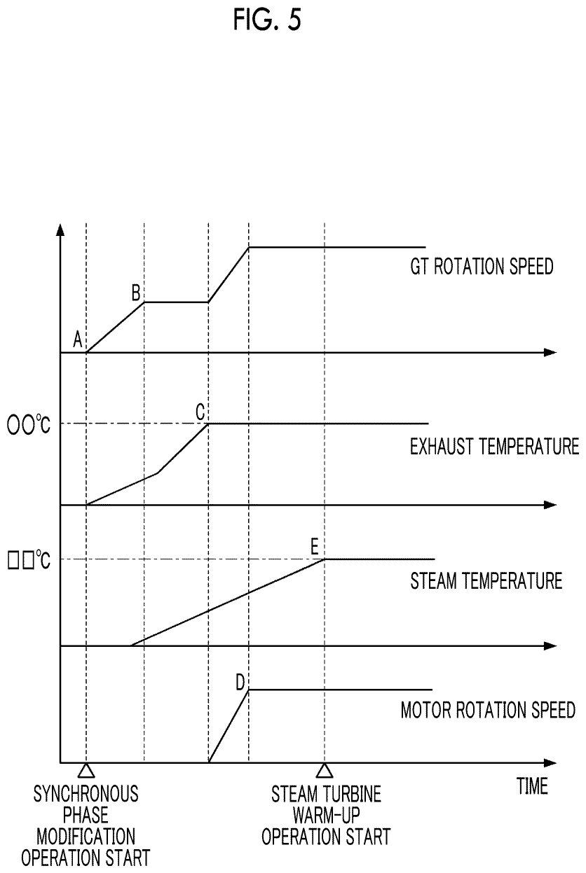

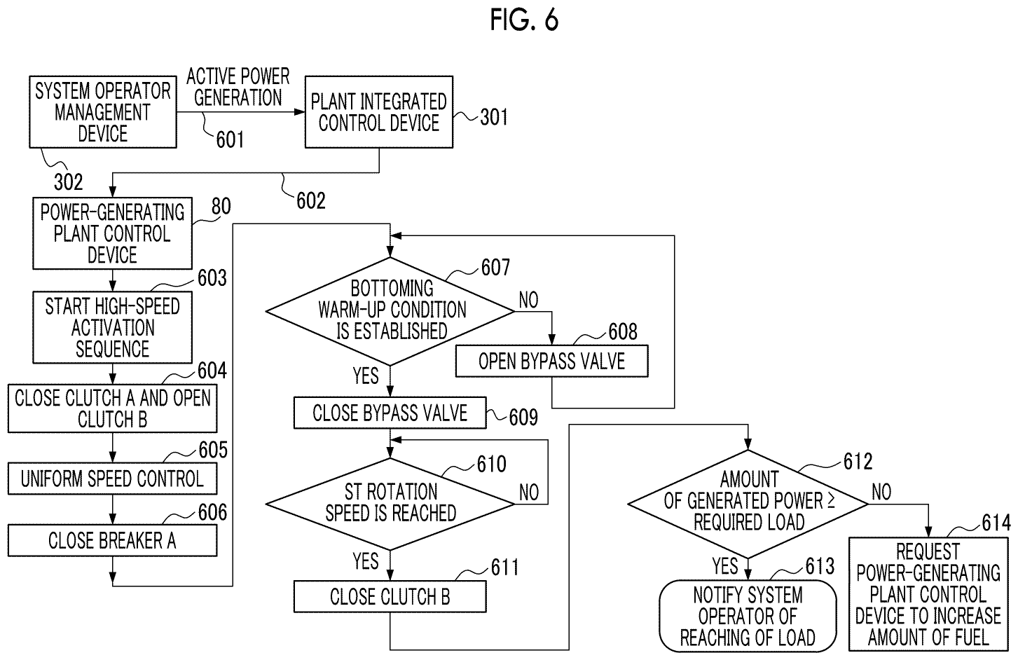

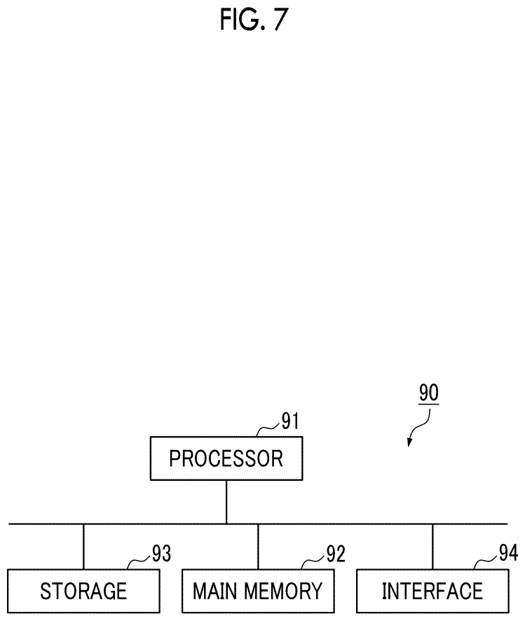

Hereinafter, embodiments of a power generation system, a control device, and a control method according to the present disclosure will be described, with reference to drawings. FIG. 1 is a diagram showing a configuration example of a power generation system according to an embodiment of the present disclosure. FIG. 2 is a diagram showing an example of measurement points of the power generation system according to the embodiment of the present disclosure. FIG. 3 is a diagram showing an example of a control processing flow during a synchronous phase modification operation of the power generation system according to the embodiment of the present disclosure. FIG. 4 is a diagram showing an example of a control flow of a bottoming warm-up operation mode of the power generation system according to the embodiment of the present disclosure. FIG. 5 is a diagram showing an operation example during the synchronous phase modification operation of the power generation system according to the embodiment of the present disclosure. FIG. 6 is a diagram showing an example of a control processing flow during a switching operation from the synchronous phase modification operation to an active power operation of the power generation system according to the embodiment of the present disclosure. FIG. 7 is a schematic block diagram showing a configuration of a computer according to at least one embodiment. In each drawing, the same reference numerals will be assigned to the same or corresponding configurations, and description thereof will be omitted as appropriate.

### First Embodiment

### (Configuration of Power Generation System)

FIG. 1 shows a configuration example of the power generation system according to the embodiment of the present disclosure. A power generation system 100 shown in FIG. 1 is a gas turbine combined cycle (GTCC) power generation system. The system includes a gas turbine 10, a heat recovery steam generator 20, a generator 30, a steam turbine 40, a rotation drive unit 50, a liquefied natural gas (LNG) tank 61, a clutch A (first clutch) 62, a clutch B (second clutch) 63, a condenser 64, steam valves 65 and 66, bypass valves 67 and 68, a transformer 71, a breaker A 72, a power-generating plant control device 80, and a plant integrated control device 301. The breaker A 72 connects or cuts off the generator 30 and a system (electric power system) 73 via the transformer 71. It should be noted that in the present embodiment, in each figure and in the description of each figure, “connection” of the breaker A 72 is also referred to as “closed”, and “cutoff” is also referred to as “open”. Further, “engagement (=transmission)” of the clutch is also referred to as “closed”, and “disengagement (=cutoff)” is also referred to as “open”.

The gas turbine 10 includes an air compressor 13, a combustor 12, a turbine 11, and a rotary shaft 14 of the turbine 11 and of the air compressor 13. The gas turbine 10 is a prime mover that causes the combustor 12 to mix and combust air compressed by the air compressor 13 and a natural gas 201 as a fuel, applies a combustion gas, which is a fluid, to rotary vanes in the turbine 11, and converts kinetic energy of the fluid into rotational motion to obtain rotational power.

The heat recovery steam generator 20 recovers exhaust heat of a gas turbine exhaust gas 202 discharged from the gas turbine 10 to generate steam 205 and 206. Further, the heat recovery steam generator 20 recovers the exhaust heat from the gas turbine exhaust gas 202, performs desulfurization treatment or the like, thereafter exhausts the gas as a heat recovery steam generator exhaust gas 203, and discharges the gas into the atmosphere from a chimney or the like not shown in the drawing.

The generator 30 is a synchronous electric machine and includes a rotary shaft 31 and a rotary shaft 32 which are coaxial. The rotary shaft 31 is detachably engaged with a rotary shaft of the gas turbine 10 via the clutch A 62. The rotary shaft 32 is detachably engaged with a rotary shaft 44 of the steam turbine 40 via the clutch B 63. The clutch A 62 and the clutch B 63 are, for example, wet multi-plate clutches. The generator 30 operates as a synchronous generator that converts power of the gas turbine 10 and of the steam turbine 40 into electric power in a state where the clutch A 62 and the clutch B 63 are both engaged, sets active power, which is requested from a system operator side, as a target, and supplies active power to the system 73. In the present embodiment, this operation mode is referred to as an active power operation. Further, in a state where both the clutch A 62 and the clutch B 63 are disengaged, the generator 30 is operated as a synchronous condenser, sets reactive power, which is requested from the system operator side, as a target, and supplies reactive power to the system 73. In the present embodiment, this operation mode is referred to as a synchronous phase modification operation. Further, in the specification or drawings, the gas turbine may be abbreviated as GT, and the steam turbine may be abbreviated as ST.

The steam turbine 40 includes a low-pressure turbine 41, a high-pressure turbine 42, and a rotary shaft 43 and a rotary shaft 44 of the low-pressure turbine 41 and of the high-pressure turbine 42. The steam turbine 40 uses steam 205, 206, or the like generated by the heat recovery steam generator 20. The low-pressure turbine 41 is a prime mover in which the steam 206 generated by the heat recovery steam generator 20 flows in via the steam valve 65 and is applied to the rotary vanes to obtain rotational power. The high-pressure turbine 42 is a prime mover in which the steam 205 generated by the heat recovery steam generator 20 flows in via the steam valve 66 and is applied to the rotary vanes to obtain rotational power.

The condenser 64 condenses the steam which has passed through the steam turbine 40 and the steam which has passed through the bypass valve 67 or 68. The water, which is recovered by the condenser 64, is returned to the heat recovery steam generator 20 as feed-water 204 via a pump or the like.

The rotation drive unit 50 rotationally drives the gas turbine 10. The rotation drive unit 50 includes an electric motor 51, a speed reducer 52, a clutch 53, and a gear group 54, and rotationally drives the gas turbine 10 by driving the electric motor 51 in a case where the clutch A 62 is in the disengaged state. The speed reducer 52 decelerates the number of rotations (=rotation speed) of the electric motor 51. The clutch 53 is, for example, a synchro-self-shifting (SSS) clutch, and transmits or cuts off the power output from the speed reducer 52. The rotation drive unit 50 includes a drive circuit (not shown in the drawing), a rotation speed detector, and the like, and rotationally drives the gas turbine 10 based on a control signal from the power-generating plant control device 80 or the like.

The power-generating plant control device 80 is an example of the control device in the present embodiment, and can be configured by using one or a plurality of computers and hardware such as peripheral devices and peripheral circuits of the computers. Further, the power-generating plant control device 80 includes a controller 81 as a functional configuration configured by a combination of hardware such as a computer and software such as a program executed by the computer. For example, the controller 81 acquires information pieces such as a steam temperature D1, a shaft rotation speed D2, a motor rotation speed D3, a feed-water flow rate D4, a GT exhaust temperature D5, a clutch state D6, and a synchronous phase modification operation D7, which are shown in FIG. 2, directly or through the plant integrated control device 301 or the other control device (not shown in the drawing). Here, the steam temperature D1 is a temperature of one or a plurality of types of steam, such as the steam 205 and 206, generated in the heat recovery steam generator 20. The shaft rotation speed D2 is a rotation speed of the rotary shaft 14. The motor rotation speed D3 is a rotation speed of the electric motor 51. The feed-water flow rate D4 is a flow rate of the feed-water 204. The GT exhaust temperature D5 is a temperature of the exhaust 202 of the gas turbine 10. The clutch state D6 is information that indicates a state in which the clutch A 62 is engaged or disengaged. The synchronous phase modification operation D7 is information that indicates whether or not the generator 30 is operated in the synchronous phase modification operation. Further, the controller 81 controls respective units such as the rotation drive unit 50, the clutch A 62, the clutch B 63, the steam valves 65 and 66, the bypass valves 67 and 68, and the breaker A 72, directly or via the plant integrated control device 301 or another control device not shown in the drawing.

In the present embodiment, for example, in a case where the generator 30 is operated in the synchronous phase modification operation in a state where the clutch A 62 is disengaged, the controller 81 controls the rotation drive unit 50 in accordance with the exhaust temperature of the gas turbine 10, thereby rotationally driving the gas turbine 10. According to this configuration, in a case where the generator 30 is operated as the synchronous condenser in a state where the clutch A 62 is disengaged, an operation state of the gas turbine 10, which is a device connected to the generator 30 via the clutch A 62, can be controlled to an optional state such as an optional rotation speed in accordance with the exhaust temperature of the gas turbine 10.

In the power generation system 100 of the present embodiment, the rotation drive unit 50 interlocking with the electric motor 51 that enables a GT low-speed operation is provided in the GT side clutch A 62. In a case where the rotary shaft 31 or the rotary shaft 32 (output shaft) of the generator 30 rotates in a case where the clutch A 62 or the clutch B 63 is not engaged, drag torque is generated due to the oil viscosity in the clutch A 62 or the clutch B 63, and corotation of the rotary shaft 14 or the rotary shaft 44 (input shaft) occurs. In such a case, a temperature rise occurs due to windage between the rotary vane and the residual air in the casing. Further, the rotation due to the corotation is not controlled.

For example, as a result of studying with a two-shaft GT, in a case where air does not flow in from the upstream, the temperature rises to about 700° C. Therefore, it has been found that the temperature rise can be adjusted by providing means for controlling the GT rotary shaft and suppressing the windage temperature rise. For example, in a case where the rotation speed of the rotary shaft is in a range of about 20% to 30% of the rated rotation speed, the temperature rise due to windage is about 350° C. In such a case, it has been found in a preliminary study that a capacity of the electric motor 51 may be in a range of about 300 to 500 kW and a plant having an amount of generated power of 100 MW or more can be realized by a constantly relatively small electric motor.

Further, in a case where the generator 30 is in a synchronous phase modification operation in a state where the clutch A 62 is disengaged, the controller 81 controls the rotation drive unit 50 in accordance with the exhaust temperature of the gas turbine 10. At this time, in a case where one or both of the steam 205 and the steam 206 reaches a predetermined temperature (□□° C. or higher), for example, the steam valves 65 and 66 are opened and the bypass valves 67 and 68 are closed, thereby ventilating the steam 205 and 206 to the steam turbine 40. According to this configuration, in a case where the generator 30 is operated as the synchronous condenser, by ventilating the steam 205 and 206 to the steam turbine 40, the steam turbine 40 can be warmed up. Thus, in a case where the synchronous phase modification operation is switched to the active power operation, an activation time of the steam turbine 40 and of the heat recovery steam generator 20 can be shortened as compared with a case where the warm-up operation is not performed. That is, in the present embodiment, it is possible to provide an operation control means suitable for warming up the GTCC bottoming by using the GT exhaust temperature due to the above-mentioned windage temperature rise.

That is, in the present embodiment, in the clutch A 62 and the clutch B 63 that disconnect the torque of the GTCC rotary shaft, the GT and the ST also rotate with the viscosity of the lubricant. Therefore, the air is heated due to the windage between the rotary shaft vanes and the air in the casing. As another example, in a case where the GT rotation speed is about 300 rpm, the air temperature may be 300° C. or higher. In the present embodiment, by performing the bottoming warm-up operation using this heat, a reactive power supply command may change to a normal active power supply command (=power generation command). In such a case, it is possible to promptly reduce a bottoming warm-up time and a time until an ST ventilation condition is established.

Further, the plant integrated control device 301 is, for example, a computer such as a server, and comprehensively controls the entire plant including the power generation system 100. For example, the plant integrated control device 301 receives an active power generation request or a reactive power generation request from a system operator management device 302, and outputs a predetermined instruction to the power-generating plant control device 80, or transfers the response from the power-generating plant control device 80 to the system operator management device 302.

Further, the system operator management device 302 is a computer such as a server operated by an operation manager of the system 73. For example, under an instruction of the operation manager, the active power generation request or the reactive power generation request is transmitted to the plant integrated control device 301.

### (Operation of Power Generation System)

First, an operation example in a case of shifting from the active power operation to the synchronous phase modification operation will be described with reference to FIGS. 3 to 5. FIG. 3 shows a control processing flow in a case where the power generation system 100 shifts from the active power operation to the synchronous phase modification operation. FIG. 4 shows a control flow in a bottoming warm-up operation mode (408) shown in FIG. 3. FIG. 5 shows an operation example of the power generation system 100 in a case of shifting to the synchronous phase modification operation.

As shown in FIG. 3, in a case of shifting from the active power operation to the synchronous phase modification operation, for example, first, the reactive power generation request (401) is sent from the system operator management device 302 to the plant integrated control device 301. The plant integrated control device 301 issues an instruction of start a time point, absorption and amounts of generated reactive power, and the like in response to the reactive power generation request (401), and instructs the power-generating plant control device 80 to shift to the synchronous phase modification operation (402). In the power-generating plant control device 80, the controller 81 first disengages the clutch A 62 and the clutch B 63 at a synchronous phase modification operation time point (403). In addition, here, the breaker A 72 is open.

Next, the controller 81 operates the generator 30 in a synchronous phase modification operation mode (404). Here, the synchronous phase modification operation mode is an operation mode in which the generator 30 is operated as a synchronous electric motor with no load and the field current is changed to generate advance or delay reactive power. Until the generator 30 reaches the rated rotation speed, the breaker A 72 is opened to cut off the connection between the system 72 and the armature winding of the generator 30, and the generator 30 is driven as an electric motor by using a thyristor drive circuit or the like. The controller 81 updates the synchronous phase modification operation D2 to “in operation”.

Next, in a case where the generator 30 reaches the rated speed (405), the controller 81 closes the breaker A 72 (406). Next, the controller 81 waits until the exhaust temperature (D5) of the gas turbine 10 is equal to or higher than a predetermined temperature (“∘∘° C.”) (407: “NO” is repeated), and executes the bottoming warm-up operation mode (408) in a case where the temperature is equal to or higher than the predetermined temperature (“∘∘° C.”) (407: “YES”). The bottoming warm-up operation mode is an operation mode for warming up a bottoming cycle in a case where a cycle of the gas turbine 10 is set as a topping cycle and a cycle attached thereto is set as a bottoming cycle in a combined engine that generates steam by using an exhaust gas from the gas turbine 10 as an input and that drives the steam turbine 40.

As shown in FIG. 4, the control flow of the bottoming warm-up operation mode includes a function 501 of the gas turbine rotation speed with respect to the gas turbine exhaust temperature, a function 502 of the motor rotation speed (the rotation speed of the electric motor 51) with respect to the gas turbine rotation speed, and a function 503 of the steam temperature with respect to the feed-water flow rate.

In the bottoming warm-up operation mode, the controller 81 issues an instruction of the start of motor operation (504) in a case where the GT exhaust temperature D5 is equal to or higher than the predetermined temperature (407: YES). The controller 81 performs an AND (logical product) calculation (505), is instructed to start the motor operation (504), and sets a calculation result to “true” in a case where the clutch state D6 indicates that the clutch A 62 is open and the synchronous phase modification operation D7 indicates that the synchronous phase modification operation is in progress.

Further, the controller 81 calculates a target value (Ref) of the GT rotation speed by using the GT exhaust temperature D5 as an input of the function 501. Furthermore, the controller 81 calculates a target value (Ref) of the motor rotation speed by using the GT rotation speed, which is output by the function 501, as the input of the function 502. In addition, the controller 81 calculates a target value (Ref) of the steam temperature by using the feed-water flow rate D4 as the input of the function 503.

Further, the controller 81 calculates a deviation by subtracting the shaft rotation speed D2 from the target value (Ref) of the GT rotation speed (Ref) (506), and calculates an adjustment amount 508 by multiplying the deviation by a predetermined gain (507). Furthermore, the controller 81 calculates a deviation by subtracting the target value (Ref) of the steam temperature (Ref) from the steam temperature D1 (509), and calculates an adjustment amount 511 by multiplying the deviation by a predetermined gain (510).

Further, the controller 81 subtracts the motor rotation speed D3 from the target value (Ref) of the motor rotation speed (Ref) (512) to calculate a deviation, performs PI calculation (proportional/integration operation) (513) on the deviation, and adds the result of the PI calculation and the adjustment amount 508 (514) to correct (=biasing) the result. Furthermore, the controller 81 adds the result of the addition (514) and the adjustment amount 511 (515) to correct (=bias) the result.

Further, the controller 81 outputs the result of the addition (515) as an output of a switch (SW) 516 in a case where the result of the AND calculation (505) is “true”, and outputs “0.0” (517) in a case where the result of the AND calculation (505) is “false”. Furthermore, the controller 81 applies a low-pass filter of a first-order delay system to the output of the switch (SW) 516 (518), generates a motor rotation speed command signal (519), and gives the output to the rotation drive unit 50.

Meanwhile, in a case where the steam temperature D1 is equal to or higher than the predetermined temperature (□□° C.) (520: YES), the controller 81 ventilates the steam turbine 40 with the steam to warm up the steam turbine 40 (522) when the result of the AND calculation (505) is “true” (the result of the AND calculation (521) is “true”).

Further, as shown in FIG. 3, after start of the bottoming warm-up operation mode (408), the controller 81 determines whether or not the required reactive power is equal to or greater than the generated reactive power (409). In a case where the required reactive power is equal to or greater than the generated reactive power (409: YES), the controller 81 notifies a system operator of the supply shortage (410). In a case where the requested reactive power is smaller than the generated reactive power (409: NO), the controller 81 notifies the system operator of the reactive power supply (411).

Here, the operation state of the power generation system 100 will be described with reference to FIG. 5. At the start of the synchronous phase modification operation (A), the rotation speed of the GT rotary shaft 14 is gradually increased, and the rotation is continued at the rotation speed (B) at which the inertial force of the GT rotary shaft and the drag torque are balanced. In such a case, the exhaust temperature rises due to the windage between the GT and the air in the casing. The motor drive is started in a case where the exhaust temperature reaches a preset warm-up operation condition (∘∘° C. or higher) (C). The motor rotation speed increases the rotation speed up to a preset motor rotation speed (D). At a time point (E) where the steam temperature is in a state suitable for the ST warm-up operation, the air is ventilated to the ST and the warm-up operation is started.

The processing flow of FIG. 4 is processing which is suitable for achieving an operation state suitable for the GTCC bottoming warm-up operation by adjusting the motor rotation speed with the GT exhaust temperature as an argument. The feed-water flow rate adjustment flow is not particularly described. However, the control of adjusting the feed-water flow rate, which is suitable for generating the preset steam temperature from measured values of the inflow exhaust temperature and the flow rate to the heat recovery steam generator 20, is not particularly limited, and an existing method may be used. In the processing flow shown in FIG. 4, a rotation speed command signal is generated by PI control such that the deviation between the target motor rotation speed and the actual rotation speed is “0”. A bias, which is obtained by multiplying the deviation between the GT rotation speed target value and the actually measured value by the adjustment gain, is added to the signal. Further, a bias, which is obtained by multiplying the deviation between the target steam temperature and the actually measured value by the adjustment gain, is added thereto. Furthermore, in a case where the signal is switched for each switching point, there is a possibility of discontinuity. Therefore, a preset stable switching change rate is added to the signal.

Next, an operation example in a case of shifting from the synchronous phase modification operation to the active power operation will be described with reference to FIG. 6. FIG. 6 shows a control processing flow in a case where the power generation system 100 shifts from the synchronous phase modification operation to the active power operation.

As shown in FIG. 6, in a case of shifting from the synchronous phase modification operation to the active power operation, for example, first, an active power generation request (601) is sent from the system operator management device 302 to the plant integrated control device 301. The plant integrated control device 301 issues an instruction of the start time point, the amount of generated active power, and the like in response to the active power generation request (601), and instructs the power-generating plant control device 80 to shift to the active power operation (602). The power-generating plant control device 80 starts a predetermined high-speed activation sequence of the gas turbine 10 and the steam turbine 40 (603), and then engages the clutch A 62 and disengages the clutch B 63 (604). In the high-speed activation sequence (603), the breaker A 72 is first cut off.

Next, the controller 81 executes uniform speed control of the gas turbine 10 (605). In the uniform speed control (605), the rotation speed is increased until the gas turbine 10 reaches the rated rotation speed. In a case where the gas turbine 10 reaches the rated rotation speed, the controller 81 performs connection to the breaker A 72 (606).

Next, the controller 81 determines whether or not the bottoming warm-up condition is satisfied (607). The bottoming warm-up condition is, for example, that the warm-up state of the steam turbine 40 is a state suitable for the operation of further flowing steam to increase the speed of the steam turbine 40 to the rated rotation speed. In a case where the bottoming warm-up condition is not satisfied (607: NO), the controller 81 keeps the bypass valves 67 and 68 open (608), and determines again whether or not the bottoming warm-up condition is satisfied (607).

In a case where the bottoming warm-up condition is satisfied (607: YES), the controller 81 closes the bypass valves 67 and 68 (609), waits until the steam turbine 40 reaches the rated rotation speed (610: NO is repeated), and engages the clutch B 63 (611) in a case where the rated rotation speed is reached (610: YES).

Next, the controller 81 determines whether or not the amount of generated power is equal to or greater than the required load (612). In a case where the amount of generated power is equal to or greater than the required load (612: YES), the controller 81 notifies the system operator of the reaching of the load (613). In a case where the amount of generated power is less than the required load (612: NO), the controller 81 requests the power-generating plant control device 80 to increase the amount of fuel (614). It should be noted that, here, instead of or in addition to the request for fuel increase, the system operator may be notified of the supply shortage.

### Operational Effects

According to the power generation system, the power-generating plant control device (control device), and the control method of the present embodiment, in a case where the generator 30 is operated as the synchronous condenser in a state where the clutch A 62 is disengaged, it is possible to control the operation state of the gas turbine 10 which is a device connected to the generator 30 via the clutch A 62.

Further, in the present embodiment, the controller 81 controls the rotation drive unit 50 to rotationally drive the gas turbine 10 in accordance with the exhaust temperature of the gas turbine 10. Therefore, the exhaust temperature of the gas turbine 10 can be easily controlled to a desired value. Therefore, the steam temperature generated by the heat recovery steam generator 20 can be easily controlled, and the steam turbine 40 can be appropriately warmed up with the steam generated by the heat recovery steam generator 20. Furthermore, in a case of switching to the active power operation, in the warm-up operation mode, in a case where the warm-up operation is already in progress, an ST rotation speed increasing operation can be immediately performed.

### OTHER EMBODIMENTS

The embodiments of the present disclosure have been described in detail with reference to the drawings. However, the specific configuration is not limited to the embodiments of the present disclosure, and includes design changes and the like without departing from the gist of the present disclosure. In addition, in the above-mentioned embodiment, the single-shaft type gas turbine combined cycle power generation system in which the gas turbine and the steam turbine are connected by the same shaft is used, but a multi-shaft type configuration may also be used. Further, the number of steam systems of the heat recovery steam generator and of the steam turbine is not limited to two low-pressure and high-pressure systems, and may be one or a plurality of systems of three or more. Furthermore, in the example shown in FIG. 4, the correction is performed by the two types of adjustment amounts 508 and 511. However, for example, one of them may be removed.

### (Configuration of Computer)

FIG. 7 is a schematic block diagram showing a configuration of a computer according to at least one embodiment.

A computer 90 includes a processor 91, a main memory 92, a storage 93, and an interface 94.

The above-mentioned power-generating plant control device 80 is mounted on the computer 90. An operation of each processing unit described above is stored in the storage 93 in a form of a program. The processor 91 reads the program from the storage 93, develops the program in the main memory 92, and performs the above-mentioned processing in accordance with the program. Further, the processor 91 ensures a storage area corresponding to each storage unit described above in the main memory 92 in accordance with the program.

The program may partially realize functions fulfilled by the computer 90. For example, the program may cause the functions to be fulfilled in combination with another program already stored in the storage or in combination with another program installed on another device. In another embodiment, in addition to the above-mentioned configuration or in place of the above-mentioned configuration, the computer may include a custom large scale integrated circuit (LSI) such as a programmable logic device (PLD). Examples of the PLD include a programmable array logic (PAL), a generic array logic (GAL), a complex programmable logic device (CPLD), and a field programmable gate array (FPGA). In such a case, functions realized by the processor may be partially or entirely realized by the integrated circuit.

Examples of the storage 93 include a hard disk drive (HDD), a solid state drive (SSD), a magnetic disk, an optical magnetic disk, a compact disc read only memory (CD-ROM), a digital versatile disc read only memory (DVD-ROM), and a semiconductor memory. The storage 93 may be internal media directly connected to a bus of the computer 90, or external media connected to the computer 90 via the interface 94 or a communication line. Further, in a case where this program is distributed to the computer 90 via the communication line, the computer 90 receiving the distribution may develop the program in the main memory 92, and may perform the above-mentioned processing. In at least one embodiment, the storage 93 is a non-temporary tangible storage medium.

### Supplementary Notes

The power generation system 100 described in the present embodiment is understood as follows, for example.

(1) According to a first aspect, the power generation system 100 includes: a gas turbine 10; a generator 30; a first clutch (clutch A 62) that engages or disengages with a rotary shaft 14 of the gas turbine 10 and a rotary shaft 31 of the generator 30; a rotation drive unit 50 that rotationally drives the gas turbine 10; and a controller 81 that controls the rotation drive unit 50 in accordance with an exhaust temperature of the gas turbine 10 to rotationally drive the gas turbine 10 in a case in which the generator 30 is in a synchronous phase modification operation while the first clutch is in a disengaged state. In the present aspect and the following aspects, in a case where the generator 30 is operated as the synchronous condenser in a state where the first clutch is disengaged, it is possible to control the operation state of the gas turbine 10 which is a device connected to the generator 30 via the first clutch.

(2) According to a power generation system 100 of a second aspect, the power generation system 100 of (1) further includes: a heat recovery steam generator 20 that recovers exhaust heat of the gas turbine 10 and that generates steam; and a steam turbine 40 that uses the steam generated by the heat recovery steam generator 20, in which the controller 81 ventilates the steam turbine 40 with the steam when a temperature of the steam reaches a predetermined temperature in a case where the rotation drive unit 50 is controlled in accordance with the exhaust temperature of the gas turbine 10. In the present aspect, the steam turbine 40 can be warmed up by utilizing the heat generated by the corotation of the clutch during the synchronous phase modification operation.

(3) According to a power generation system 100 of a third aspect, in the power generation system 100 of (1) or (2), in a case where the controller 81 controls the rotation drive unit 50 in accordance with the exhaust temperature of the gas turbine 10, the controller 81 controls the rotation drive unit 50, in accordance with a deviation between a target rotation speed of the rotation drive unit 50, which is set in accordance with the exhaust temperature of the gas turbine 10, and an actual rotation speed of the rotational drive unit 50 and a deviation between a target rotation speed of the gas turbine 10, which is set in accordance with the exhaust temperature of the gas turbine 10, and an actual rotation speed of the gas turbine 10.

(4) According to a power generation system 100 of a fourth aspect, in the power generation system 100 of (2), in a case where the controller 81 controls the rotation drive unit 50 in accordance with the exhaust temperature of the gas turbine 10, the controller 81 controls the rotation drive unit 50, in accordance with at least one of a deviation between a target rotation speed of the gas turbine 10, which is set in accordance with the exhaust temperature of the gas turbine 10, and an actual rotation speed of the gas turbine 10 or a deviation between a target steam temperature, which is set in accordance with an amount of water fed to the heat recovery steam generator 20, and an actual temperature of the steam and a deviation between a target rotation speed of the rotation drive unit 50, which is set in accordance with the exhaust temperature of the gas turbine 10, and an actual rotation speed of the rotation drive unit 50.

(5) According to a power generation system 100 of a fifth aspect, in the power generation system 100 of (2) or (4), in a case where a rotary shaft 44 of the steam turbine 40 is engaged with the rotary shaft 32 of the generator 30 via a second clutch (clutch B 63) and the synchronous phase modification operation is switched to an active power operation, in a state where the generator 30 is cut off from a system 73, the generator 30 is driven by the gas turbine 10 in a state where the first clutch is engaged and the second clutch is disengaged, and the generator 30 is connected to the system 73, and the second clutch is engaged by increasing a rotation speed of the steam turbine 40 in a case where a warm-up state of the steam turbine 40 satisfies a predetermined condition.

### INDUSTRIAL APPLICABILITY

According to the aspects of the present invention, in a case where the generator is operated as the synchronous condenser in a state where the clutch is disengaged, it is possible to control the operation state of the device connected to the generator via the clutch.

### REFERENCE SIGNS LIST

100: power generation system
10: gas turbine
20: heat recovery steam generator
30: generator
40: steam turbine
50: rotation drive unit
51: electric motor
62: clutch A
63: clutch B
72: breaker A
73: system
80: power-generating plant control device
81: controller

1. A power generation system comprising:
a gas turbine;
a generator;
a first clutch that engages or disengages with a rotary shaft of the gas turbine and a rotary shaft of the generator;
a rotation drive unit that rotationally drives the gas turbine; and
a controller that controls the rotation drive unit in accordance with an exhaust temperature of the gas turbine to rotationally drive the gas turbine in a case in which the generator is in a synchronous phase modification operation while the first clutch is in a disengaged state.

2. The power generation system according to claim 1, further comprising:
a heat recovery steam generator that recovers exhaust heat of the gas turbine and that generates steam; and
a steam turbine that uses the steam generated by the heat recovery steam generator,
wherein the controller ventilates the steam turbine with the steam when a temperature of the steam reaches a predetermined temperature in a case where the rotation drive unit is controlled in accordance with the exhaust temperature of the gas turbine.

3. The power generation system according to claim 1,
wherein in a case where the controller controls the rotation drive unit in accordance with the exhaust temperature of the gas turbine, the controller controls the rotation drive unit, in accordance with a deviation between a target rotation speed of the rotation drive unit, which is set in accordance with the exhaust temperature of the gas turbine, and an actual rotation speed of the rotation drive unit and a deviation between a target rotation speed of the gas turbine, which is set in accordance with the exhaust temperature of the gas turbine, and an actual rotation speed of the gas turbine.

4. The power generation system according to claim 2, wherein in a case where the controller controls the rotation drive unit in accordance with the exhaust temperature of the gas turbine, the controller controls the rotation drive unit, in accordance with at least one of a deviation between a target rotation speed of the gas turbine, which is set in accordance with the exhaust temperature of the gas turbine, and an actual rotation speed of the gas turbine or a deviation between a target steam temperature, which is set in accordance with an amount of water fed to the heat recovery steam generator, and an actual temperature of the steam and a deviation between a target rotation speed of the rotation drive unit, which is set in accordance with the exhaust temperature of the gas turbine, and an actual rotation speed of the rotation drive unit.

5. The power generation system according to claim 2,
wherein in a case where a rotary shaft of the steam turbine is engaged with the rotary shaft of the generator via a second clutch and the synchronous phase modification operation is switched to an active power operation,
in a state where the generator is cut off from a system, the generator is driven by the gas turbine in a state where the first clutch is engaged and the second clutch is disengaged, and the generator is connected to the system, and
the second clutch is engaged by increasing a rotation speed of the steam turbine in a case where a warm-up state of the steam turbine satisfies a predetermined condition.

6. A control device that controls a power generation system including
a gas turbine,
a generator,
a first clutch that engages or disengages with a rotary shaft of the gas turbine and a rotary shaft of the generator, and
a rotation drive unit that rotationally drives the gas turbine,
the control device comprising:
a controller that controls the rotation drive unit in accordance with an exhaust temperature of the gas turbine to rotationally drive the gas turbine in a case in which the generator is in a synchronous phase modification operation while the first clutch is in a disengaged state.

7. A control method of a power generation system including
a gas turbine,
a generator,
a first clutch that engages or disengages with a rotary shaft of the gas turbine and a rotary shaft of the generator, and
a rotation drive unit that rotationally drives the gas turbine,
the control method comprising:
controlling the rotation drive unit in accordance with an exhaust temperature of the gas turbine to rotationally drive the gas turbine in a case in which the generator is in a synchronous phase modification operation while the first clutch is in a disengaged state.
